(19) United States
(12) Patent Application Publication
(10) Pub. No.: US 2025/0156159 A1
(43) Pub. Date: May 15, 2025

(54) COMPUTATION GRAPH OPTIMIZATION METHOD, DATA PROCESSING METHOD AND RELATED PRODUCT

(71) Applicant: CAMBRICON TECHNOLOGIES CORPORATION LIMITED, Beijing (CN)

(72) Inventors: GANG SHAN, Beijing (CN); YUEFENG LIANG, Beijing (CN); FENGYANG SI, Beijing (CN); WEI GU, Beijing (CN); XIUCHUAN ZHAI, Beijing (CN); JIN WANG, Beijing (CN); JINHONG ZHOU, Beijing (CN)

(21) Appl. No.: 18/714,317

(22) PCT Filed: Nov. 18, 2022
(86) PCT No.: PCT/CN2022/132745

§ 371 Date: Dec. 10, 2024

(30) Foreign Application Priority Data
Nov. 29, 2021 (CN) 202111433244.5
Nov. 29, 2021 (CN) 202111433279.9
Nov. 29, 2021 (CN) 202111435823.3

(51) Int. Cl. G06F 8/41; G06F 8/36

(52) U.S. Cl. CPC G06F 8/41; G06F 8/36

(57) ABSTRACT

A computing apparatus performing a computing graph optimization method is included in a combined processing apparatus. The combined processing apparatus includes an interface apparatus and other processing apparatus. The computing apparatus interacts with other processing apparatus to jointly complete a computing operation specified by a user. The combined processing apparatus further includes a storage apparatus which is connected to the computing apparatus and other processing apparatus respectively and is configured to store data of the computing apparatus and other processing apparatus. The disclosed scheme may optimize data access by constructing a view-class operator subgraph. By optimizing the view-class operator subgraph, memory moving and operator calling on the device side may be reduced. By reversely deducing a view-class operator that causes tensor data to become a memory discontiguous state, a suitable computing library operator may be called to convert the tensor data into a memory contiguous state.

### BACKGROUND

### 1. Technical Field

This disclosure relates to the field of intelligent computing in general and compilation in particular. More specifically, this disclosure relates to a computing graph optimization method, a data processing method, a computing apparatus, a computer readable storage medium, and a computer program product.

### 2. Background Art

In an intelligent computing system, a programming framework provides programmers with an interface of using hardware and system, which is a very key core hub in the intelligent computing system. On one hand, the programming framework may encapsulate common operations in the algorithm into operators for programmers to call directly, such as convolution, pooling, etc. On the other hand, as an interface between hardware and software, the programming framework may encapsulate a hardware architecture, thereby reducing the complexity and difficulty of writing or applying deep learning algorithms and improving the implementation efficiency of algorithms.

TensorFlow and PyTorch are current popular deep learning frameworks. In these programming frameworks, a computing graph is usually used to describe a computing process of machine learning algorithms, tensors are used to represent all data in the computing graph, and operators are used to represent various operations. There is such a class of operators, such as transpose, slice, split, etc., which changes the external performance or appearance of the tensor data, but does not change the real arrangement of the tensor data in memory, which means that real memory data moving is not performed. This class of operators may be called view-class operators.

Due to this property of the view-class operators, the tensor data is usually discontiguous in memory, which means that a dimension order of the tensor data is not consistent with its storage order. Reading the discontiguous data for computations will cause low memory access efficiency and high time consuming of hardware devices. Moreover, when there are many view-class operators, a lot of memory data contiguity processing is required, resulting in a huge time overhead. In addition, for some high performance computing libraries, such as a CNNL, most operators require that input tensors are contiguous in memory. A current processing method is to call a specific operator to move and rearrange data one piece by one piece, so as to make tensors be contiguous in memory and then be transmit to a next operator in the computing library. This mode of moving and rearranging data one piece by one piece is time-consuming and results in poor overall performance.

### SUMMARY

In order to at least partly solve one or more technical problems mentioned in the background, the present disclosure provides a scheme in many aspects. A first aspect of the present disclosure provides a computing graph optimization method that constructs a view-class operator subgraph for subsequent memory data contiguity processing. A second aspect of the present disclosure provides a further computing graph optimization method that performs an operator fusion according to the interrelation of view-class operators based on a pre-constructed view-class operator subgraph, thus reducing data moving in memory and operator calling on the device side and then improving data access efficiency. A third aspect of the present disclosure provides a data processing method that performs memory data contiguity processing based on a pre-constructed/optimized view-class operator subgraph, thus improving data access efficiency. A fourth aspect of the present disclosure provides a data processing scheme that calls a suitable data moving operator in a computing library to convert tensor data in a memory discontiguous state into tensor data in a memory contiguous state, thus improving data access efficiency and adapting to the requirement of operators in a high performance computing library.

In a first aspect, the present disclosure discloses a computing graph optimization method, including: traversing an operator associated with tensor data in a computing graph; and extracting the operator to construct a view-class operator subgraph when the operator is a view-class operator, where the view-class operator subgraph is used to perform memory data contiguity processing.

In a second aspect, the present disclosure discloses a computing graph optimization method, including: acquiring a view-class operator subgraph of tensor data in a computing graph, where the view-class operator subgraph includes a view-class source operator associated with the tensor data; replacing the source operator with a target operator whose specified function is interchangeable with that of the source operator according to a function of the source operator in the view-class operator subgraph; and fusing a plurality of contiguous identical target operators into a single target operator to generate a fused view-class operator subgraph.

In a third aspect, the present disclosure discloses a data processing method, including: acquiring a view-class operator subgraph of to-be-processed tensor data in response to the tensor data being discontiguous in memory, where the view-class operator subgraph is constructed according to the method of the first aspect of the present disclosure or optimized according to the method of the second aspect of the present disclosure; and calling a corresponding kernel to perform data moving according to information of the view-class operator subgraph to convert the tensor data into tensor data that is contiguous in memory.

In a fourth aspect, the present disclosure discloses a data processing method, including: determining a view-class operator through which a to-be-processed first tensor converts from a memory contiguous state into a memory discontiguous state according to first description information of the first tensor in response to the first tensor being in the memory discontiguous state; determining a data moving operator in a computing library that is required to be called according to the view-class operator; determining a parameter required for calling the data moving operator to convert the first tensor from the memory discontiguous state into the memory contiguous state according to the first description information; and calling the data moving operator according to the parameter to convert the first tensor into the memory contiguous state.

In a fifth aspect, the present disclosure discloses a computing apparatus, including: a processor configured to perform a program instruction; and a storage configured to store the program instruction, where when the program instruction is loaded and executed by the processor, the processor performs the computing graph optimization method based on the first or second aspect of the present disclosure, or the data processing method based on the third or fourth aspect of the present disclosure.

In a sixth aspect, the present disclosure discloses a computer readable storage medium, on which a program instruction is stored, where when the program instruction is loaded and performed by a processor, the processor performs the computing graph optimization method based on the first or second aspect of the present disclosure, or the data processing method based on the third or fourth aspect of the present disclosure.

In a seventh aspect, the present disclosure discloses a computer program product, including a computer program or instruction, where when the computer program or instruction is performed by a processor, the computing graph optimization method based on the first or second aspect of the present disclosure, or the data processing method based on the third or fourth aspect of the present disclosure is implemented.

According to the computing graph optimization method provided above, on one hand, view-class operators in the computing graph may construct a subgraph, so that memory contiguity processing of data may be optimized based on this view-class operator subgraph, thus improving data access efficiency. On the other hand, the operator subgraph pre-constructed based on the view-class operators in the computing graph may be optimized by fusing operators of the same type, thus reducing data moving in memory and operator calling and then improving data access efficiency. In addition, according to the data processing scheme provided above, it is possible to reversely deduce the view-class operator in the computing graph that causes the tensor data to convert from the memory contiguous state into the memory discontiguous state according to the description information of the tensor data in the memory discontiguous state. Accordingly, a suitable high performance computing library operator is selected to perform data moving. Under this data moving processing, contiguous data moving is performed based on tensor data, thereby increasing processing efficiency and improving overall performance.

### BRIEF DESCRIPTION OF THE DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIGS. 1A to 1D exemplify different shapes of a multidimensional array and its storage order on a storage.

FIG. 2 shows an exemplary flowchart of a computing graph optimization method according to an embodiment of the present disclosure.

FIG. 3 shows an exemplary flowchart of a computing graph optimization method according to another embodiment of the present disclosure.

FIG. 4A-4C show structures of several exemplary computing graphs and structures of correspondingly constructed view-class operator subgraphs.

FIG. 5A-5B show simple examples of operator fusions.

FIG. 6 shows an exemplary method flowchart of an operator fusion according to some embodiments of the present disclosure.

FIG. 7 shows an exemplary flowchart of a data processing method according to some embodiments of the present disclosure.

FIG. 8 shows an exemplary flowchart of a data processing method according to some embodiments of the present disclosure.

FIG. 9 shows an exemplary flowchart of a data processing method according to an embodiment of the present disclosure.

FIG. 10 shows an exemplary flowchart of a data processing method according to another embodiment of the present disclosure.

FIG. 11 shows a block diagram of a hardware configuration of a computing apparatus that may implement various schemes according to an embodiment of the present disclosure.

FIG. 12 shows a structural diagram of a combined processing apparatus according to an embodiment of the present disclosure.

FIG. 13 shows a schematic structural diagram of a board card according to an embodiment of the present disclosure.

### DETAILED DESCRIPTION

Technical schemes in embodiments of the present disclosure will be described clearly and completely hereinafter with reference to the drawings in the embodiments of the present disclosure. Obviously, the embodiments to be described are merely some rather than all examples of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” appear in the claims, specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context.

Embodiments of the present disclosure will be described in detail in combination with drawings below.

In a programming framework of an intelligent computing system, data is typically modeled as a tensor. The tensor may be viewed as an N-dimensional array, and a dimension count of the array is an order count of the tensor. Therefore, a zero-order tensor corresponds to scalar data; a one-order tensor corresponds to a one-dimensional array, which is a vector; a two-order tensor corresponds to a two-dimensional array, which is a matrix; and by analogy, an N-order tensor corresponds to an N-dimensional array. For example, an RGB (red, green, blue) image may be represented as a three-order tensor, while a dataset of multiple RGB images may be represented as a four-order tensor.

Every tensor has some common properties, including a data type, a shape, and so on. The shape of the tensor represents a length of each order of the tensor. For example, a zero-order tensor corresponds to a piece of scalar data whose shape is empty; a one-order tensor corresponds to a one-dimensional vector whose shape contains one element whose value is a length of the vector; a two-order tensor corresponds to a matrix whose shape contains two elements corresponding to lengths of a row and a column respectively; and a three-order tensor corresponds to a piece of three-dimensional data whose shape contains three elements corresponding to lengths of three orders respectively.

Although a multidimensional array has a plurality of dimensions, because a layout of a storage (such as a memory DRAM (dynamic random access memory) and a cache RAM (random access memory)) is always one-dimensional, there is a correspondence between the multidimensional array and its storage order on the storage. The multidimensional array is usually allocated in contiguous storage space, which means that the multidimensional array may be expanded in one dimension and stored sequentially on the storage.

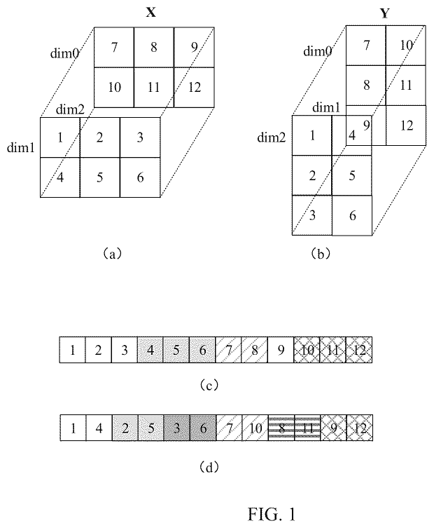

FIGS. 1A to 1D exemplify different shapes of a multidimensional array and its storage order on a storage, where a one-dimensional array of contiguous memory is used to realize the storage of the multidimensional array.

The FIG. 1A illustrates first data, namely a three-dimensional array X, which has three dimensions, namely a dimension 0 (dim0), a dimension 1 (dim1), and a dimension 2 (dim2). A size of the dimension 0 is 2, a size of the dimension 1 is 2, and a size of the dimension 2 is 3. Therefore, a shape (size) of the first data may be expressed as X₃=(2,2,3).

The FIG. 1C illustrates a storage order of the three-dimensional array X on a storage, where data with the same background in the figure are in the same dimension. When storing, assuming that the order of storage is in accordance with a low dimension priority mode (for example, from left to right corresponds to from high dimension to low dimension in the shape representation), the first data is expanded in one dimension, thus obtaining:

X=[1,2,3,4,5,6,7,8,9,10,11,12].

More specifically, data in the lowest dimension (the same row) are contiguous, while data in higher dimensions are separated by different distances. For example, in the storage mode shown in FIG. 1C, accessing to a physical structure of adjacent elements on the dim2 requires an offset of 1 position (for example, from data 1 to data 2, data 5 to data 6, and so on); accessing a physical structure of adjacent elements on the dim1 requires an offset of 3 positions (for example, from data 1 to data 4, data 2 to data 5, . . . , data 9 to data 12, and so on); and accessing a physical structure of adjacent elements on the dim0 requires an offset of 6 positions (for example, from data 1 to data 7, data 2 to data 8, . . . , data 6 to data 12, and so on). This offset is called a stride. The stride of each dimension of the three-dimensional array X may be expressed as S_{X}=(6,3,1).

In the programming framework of the intelligent computing system, there are view-class operators that process external representations of tensors, such as transpose, slice, split, and the like. Taking transpose as an example, a data arrangement after a dimension conversion is obtained according to some dimension conversion rule perm_{N}=(p₁, p₂, . . . , pᵢ, . . . , p_{N}), where a value of pᵢ(i∈1,2, . . . , N) represents an original dimension of an array, and a position of pᵢ in perm_{N} represents a target dimension of the conversion. For example, given a dimension conversion rule perm₃=(0,2,1), it means that a dimension 1 is to be swapped with a dimension 2, which means that an original dimension 1 is to be converted into a dimension 2 of anew array, and an original dimension 2 is to be converted into a dimension 1 of a new array.

The FIG. 1B shows a converted array Y after a transpose operator is performed on the three-dimensional array X shown in the FIG. 1A. In this example, the above exemplary dimension conversion rule perm₃=(0,2,1) is applied. It may be seen from the figure that compared with the array X, the dimension 1 and the dimension 2 of the array Y are swapped. At this time, the dimension information of the three-dimensional array Y may be represented as Y₃=(2,3,2).

However, since the view-class operator does not change a storage position of data on a storage, the storage order of the array Y obtained after the transpose operation is still shown as FIG. 1C. At this time, according to the storage order in (c), the stride of each dimension of the array Y becomes S_{Y}=(6,1,3). It may be seen that if storing data sequentially with the principle of low dimension priority is called contiguity, the current storage order of the array Y is discontiguous. In other words, after the transpose operator, because the dimension order of the array is changed, but the storage position of the array on the storage is not changed, the storage order of the array on the memory becomes discontiguous.

If the array Y is expected to be contiguous on the storage, its one-dimensional expansion should be as shown as FIG. 1D according to the principle of low dimension priority:

Y=[1,4,2,5,3,6,7,10,8,11,9,12].

In this paper, when the one-dimensional expansion of the tensor data in dimension order is consistent with the storage order of the data on the storage, the tensor data is said to be in an “memory contiguous state”, and conversely, in an “memory discontiguous state”. It may also be seen from the example of FIGS. 1A to 1D that the dimension stride of the tensor data is arranged in a descending order when the tensor data is in the “memory contiguous state”. For example, the dimension stride S_{X}=(6,3,1) of the tensor X is arranged in a descending order: the dimension stride S_{Y}=(6,1,3) of the tensor Y is arranged in a non-descending order.

The shape of the tensor may help programmers form an intuitive sense of the tensor. In programming frameworks such as Pytorch, the view-class operator may change properties such as a shape (size), a stride (a span of a first index between adjacent dimensions of the tensor), and a storage offset (storage_offset, an offset of a first element of the tensor relative to a starting storage position) of the tensor, but does not change the real storage position of the tensor. At this time, the tensor computes the memory position of the data on the device side by using the size, the stride, and the storage_offset.

Assuming that the size of the tensor is (s₀, s₁, s₂, . . . , sᵢ), the stride of the tensor is (y₀,y₁,y₂, . . . , yᵢ), and the storage_offset of the tensor is b, the basic computing formula for the tensor at the memory position corresponding to the point (x₀, x₁, x₂, . . . , xᵢ) is as follows:

dptr₍ₓ_{₀}_{,x}_{₁}_{,x}_{₂}_{, . . . ,x}_{ᵢ}₎=dptr+(b+x₀*y₀+x₁*y₁ . . . +xᵢ*yᵢ)*sizeof(dtype).

In the formula, dptr is a starting storage position of the tensor on the memory, which means that storage_offset, and dtype is a data type of the tensor.

It may be seen from the above description in combination with FIGS. 1A to 1D that the tensor in the computing graph generates discontiguous corresponding data after being processed by the view-class operator, which means that the state of the tensor becomes the memory discontiguous state. The view-class operator does not copy or change the data stored in the tensor, but simply redefines the correspondence between the subscript and the data element in the tensor. When the tensor in the memory discontiguous state is accessed, the traditional CPU (central processing unit) and GPU (graphics processing unit) need to access and read the discontiguous data according to the above formula, which leads to low memory access efficiency and high time consuming problems of hardware devices. Another method is to call a contiguous( ) operator to move the data one piece by one piece into contiguous storage according to the above formula, and then perform subsequent access and operations. However, when high-performance neural network computing libraries (such as CNNL) are used to perform various operations on tensors, most operators will require that an input tensor must be in a memory contiguous state, otherwise an error will occur. At this time, a specific operator (such as a cnnlStrideCopy operator) is required to be called first. According to the above formula, data is moved one piece by one piece into contiguous storage, and the above tensor is converted into the tensor in the memory contiguous state and then transmit to a next CNNL operator. However, these methods are very time-consuming, in the case of a large amount of data, moving the data one piece by one piece will bring great time consumption.

In view of this, considering that in the operation of computing graphs of, for example, neural networks, discontinuity of data in memory is often caused by view-class operators, this disclosure proposes a scheme of constructing a view-class operator subgraph based on view-class operators in a computing graph. This view-class operator subgraph may then support the subsequent efficient moving of memory data from discontiguous to contiguous.

With respect to terms “node” and “operator” mentioned in this disclosure, it should be noted that the term “operator” is used at the computing level of a computer (or at a software or algorithmic level), and the term “node” is a more figurative term (the term “node” is used at a graphical or more intuitive level). In terms of what the terms refer to, the terms “operator” and “node” actually refer to the same thing. In other words, in the present disclosure, the terms “operator” and “node” may be considered as having the same meaning and may be used interchangeably, but are described from different sides.

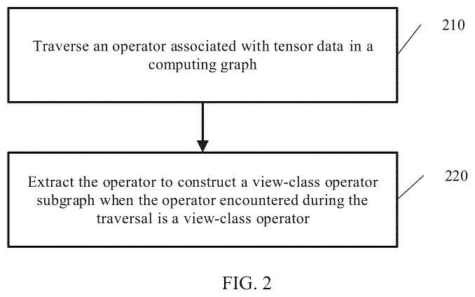

FIG. 2 shows an exemplary flowchart of a computing graph optimization method according to an embodiment of the present disclosure. In this optimization method, a view-class operator subgraph is constructed to support the subsequent memory data contiguity processing.

As shown in the figure, in step 210, an operator associated with tensor data in a computing graph is traversed.

The computing graph is a directed graph that includes nodes and edges, and the tensor is transmit among the nodes of the computing graph. The computing graph is executed according to the order of the directed graph, and every time the tensor passes through a node, it is used as the input of the operation of the node and then computed, and the result of the computation flows along the output edge of the node to the subsequent node. Therefore, when the view-class operator subgraph is constructed, for the tensor data, the node or operator that processes the tensor data is traversed according to the order of the directed graph.

Then, in step 220, the operator is extracted to construct the view-class operator subgraph when the operator encountered during the traversal is a view-class operator.

In some embodiments, extracting the view-class operator to construct the view-class operator subgraph may include: associatively caching the operator information and operator sequence number of the operator; and adding the operator sequence number to the view-class operator subgraph. In these embodiments, the structure of the view-class operator subgraph may be simplified by storing the operator information separately from the view-class operator subgraph and establishing the relationship between them by the operator sequence number, which is convenient for the subsequent memory data contiguity processing.

Each operator has properties that identify information about the execution of the operation. Common properties include an operator name, an operator type, operator input data, operator output data, and computation parameters. In some embodiments, the operator information cached above may include at least one of the following: description information of input data of the operator, description information of output data of the operator, and computation parameters of the operator. It may be understood that both the input and output data of the operator are tensor data, and the description information of the tensor data mainly includes the previously mentioned shape, stride, storage offset, and so on.

The computation parameters of the operator are associated with the function of the operator. For example, taking a transpose operator as an example, its computation parameters may include two dimensions to be swapped (dim0, dim1). For example, for a chunk operator, its function is to chunk the tensor according to the dim on average, and its corresponding computation parameters may include the number of chunks to be chunked and the dims to be chunked.

The above describes extracting view-class operators that cause discontinuity of memory data to construct a view-class operator subgraph to support subsequent memory data contiguity processing. It may be understood that for each tensor data, a view-class operator subgraph of that tensor data may be constructed. Further, it may also be understood that each tensor data may include multi-segment view-class operator subgraphs depending on the contiguity of the view-class operators in the computing graph.

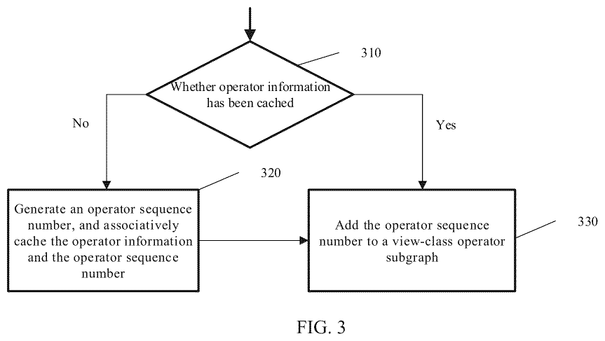

FIG. 3 shows an exemplary flowchart of a computing graph optimization method according to another embodiment of the present disclosure. In this embodiment, the construction of the view-class operator subgraph may be further optimized to simplify the storage of information.

As shown in the figure, when the operator is extracted to construct the view-class operator subgraph, for the encountered view-class operator, in step 310, it is checked first whether the operator information of the operator has been cached on the memory. The operator information, for example, may include the description information of the input data, the description information of the output data, and the computation parameters of the operator mentioned above.

If the operator information is not cached, the operator is a new operator compared with the operators on the memory, and the process proceeds to step 320, where the operator sequence number is generated for the operator, and the operator information and the operator sequence number are associatively cached as previously mentioned. Further, in step 330, the operator sequence number is added to the view-class operator subgraph.

If the operator information has been cached, there is no need to cache the same information repeatedly. Instead, the process proceeds directly to step 330, where the operator sequence number of the operator that has been cached is added to the view-class operator subgraph.

The above processing method may effectively reduce the amount of information cached and simplify the construction of the view-class operator subgraph.

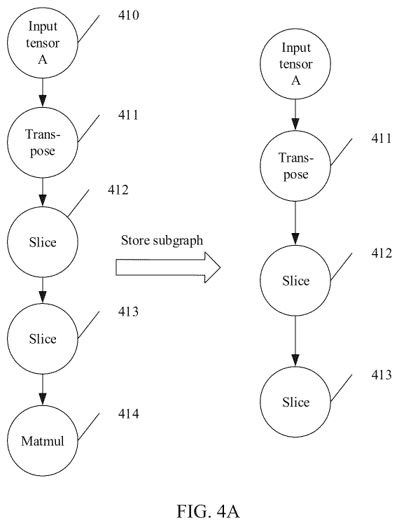

FIG. 4A-4C show structures of several exemplary computing graphs and structures of correspondingly constructed view-class operator subgraphs.

FIG. 4A shows a computing graph with a unidirectional structure, where an input tensor A 410 passes through the following nodes according to the flow direction of the computing graph: a transpose operator 411, a slice operator 412, a slice operator 413, and an Matmul (matrix multiplication) operator 414. Among these operators, the transpose operator 411, the slice operator 412, and the slice operator 413 belong to view-class operators, and the Matmul (matrix multiplication) operator 414 is a computation-class operator.

According to the construction scheme of the view-class operator subgraph in the embodiment of this disclosure, these view-class operators are extracted to form the view-class operator subgraph. As shown on the right in FIG. 4A, for the input tensor A, the view-class operator subgraph includes the transpose operators 411, the slice operators 412, and the slice operators 413 in turn.

In some embodiments, assuming that the operator sequence number of the transpose operator 411 is 1, the operator sequence number of the slice operator 412 is 2, and the operator sequence number of the slice operator 413 is 3, then by using these operator sequence numbers, the constructed view-class operator subgraph may be expressed as 1->2->3. The operator information of the corresponding operators may be extracted from the cached information through the operator sequence numbers.

In some embodiments, assuming that the slice operator 412 and the slice operator 413 have the same operator information, they may store one copy of the operator information and share the same operator sequence number. In this embodiment, when the slice operator 413 is processed and the operator information of the slice operator 413 is found to be the same as the operator information cached for the previous slice operator 412, the caching step is not required to be performed, but the operator sequence number 2 of the cached slice operator 412 is directly assigned to the slice operator 413 and added to the view-class operator subgraph. At this point, the constructed view-class operator subgraph is represented by the operator sequence numbers as 1->2->2.

FIG. 4B shows a computing graph with a residual structure, where an input tensor B 420 passes through the following nodes according to the flow direction of the computing graph: a view operator 421, a Conv (convolution) operator 422, an Act (activation) operator 423, and an Add (addition) operator 424, where an output of the view operator 421 is also input to the Add operator 424 as another addend. Among these operators, the view operator 421 belongs to a view-class operator, and the rest are computation-class operators.

According to the construction scheme of the view-class operator subgraph in the embodiment of this disclosure, the view-class operator included in the computing graph is extracted to form the view-class operator subgraph. As shown on the right in FIG. 4B, for the input tensor B, the view-class operator subgraph includes the view operator 421.

FIG. 4C shows a computing graph with a multi-branch structure, where an input tensor C 430 passes through the following nodes according to the flow direction of the computing graph: a split operator 431, a transpose1 operator 432, a transpose2 operator 433 and a transpose3 operator 434 on three branches respectively, a BMM1 operator 435 performing computations on outputs of first and second branches, a Softmax operator 436, and a BMM2 operator 437 performing computations on a computation result of first two branches and an output of a third branch. Among these operators, the split operator 431 and three transpose operators 432-434 belong to view-class operators, and the rest are computation-class operators.

According to the construction scheme of the view-class operator subgraph in the embodiment of this disclosure, the view-class operators included in the computing graph are extracted to form the view-class operator subgraph. As shown on the right in FIG. 4C, for the input tensor C, the view-class operator subgraph may be divided into three branches according to the computation parameters of the split operator 431, such as the number of data blocks split into, where each branch includes a split operator 431 and one of corresponding transpose operators 432-434. It may be seen that when the view-class operator is a multi-branch operator, a view-class operator subgraph with a corresponding number of branches may be constructed based on the multi-branch operator.

The construction scheme of the view-class operator subgraph provided by the embodiment of this disclosure is described by combining several examples above. As can be seen from the view-class operator subgraph constructed above, the current view-class operator subgraph extracts contiguous view-class operators without further processing. When there are a large number of view-class operators, the memory data contiguity processing based on these view-class operators one by one leads to frequent operator calling and data moving, resulting in repeated memory access, low memory access efficiency, and increased network time consuming.

A typical computing graph optimization is an operator fusion, where a plurality of operators are computed together in a single kernel without saving intermediate results back into a global memory.

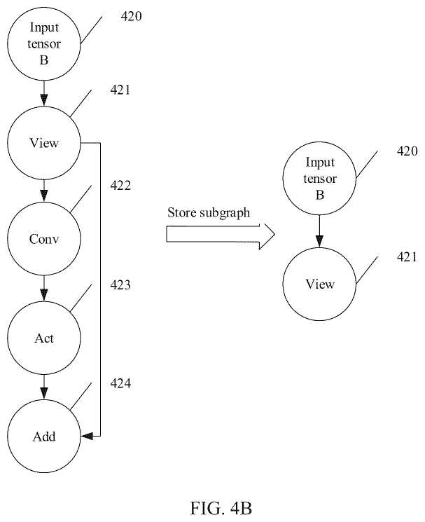

To better understand the operator fusion, FIGS. 5A-5B show simple examples of the operator fusion.

It is assumed that there are two operators that are performed in sequence in the figure: a 1st operator and a 2nd operator, which are replaced by \textcircled{1} and \textcircled{2} in the following. FIG. 5A shows a computation process without an operator fusion, and the computation process is as follows:
1) reading an input (an input of \textcircled{1}) of the entire computing graph from a DRAM to an on-chip storage, such as a PNM (parallel neuron memory), and reading a weight of \textcircled{1} to an on-chip storage, such as a PWM (parallel weight memory);
2) fetching, by a PFU (parallel functional unit), data from the PNM and the PWM to completes computations, and writing a result of \textcircled{1} back to the PNM;
3) writing the result of \textcircled{1} from the PNM back to the DRAM as an input of \textcircled{2};
then performing the 2nd operator \textcircled{2};
4) reading the input of \textcircled{2} from the DRAM to the PNM, and reading the weight of \textcircled{2} to the PWM;
5) fetching, by the PFU computation unit, data from the PNM and the PWM to completes computations, and writing a result of \textcircled{2} back to the PNM;
6) writing the result of \textcircled{2} back to the DRAM as an output of the entire computing graph.

FIG. 5B shows a computation process with an operator fusion, and the computation process is as follows:
A) reading an input (an input of \textcircled{1}) of the entire computing graph from a DRAM to a PNM, and reading weights of \textcircled{1} and \textcircled{2} to a PWM;
B) fetching, by a PFU computation unit, data from the PNM and the PWM to completes computations, and writing a result of \textcircled{1} back to the PNM;
C) fetching, by the PFU computation unit, data from the PNM and the PWM to completes computations, and writing a result of \textcircled{2} back to the PNM;
D) writing the result of \textcircled{2} back to the DRAM as an output of the entire computing graph.

From the comparison of the above two processes, it may be seen that the operator fusion may reduce the steps 3) and 4) in the computation process before the operator fusion, which means that the operator fusion may reduce the redundant moving of the same piece of data (in this example, the result of \textcircled{1}, which is used as the input of \textcircled{2}) from PNM->DRAM and DRAM->PNM: in other words, the operator fusion may reduce the data access steps for intermediate results, thereby increasing the speed of computations.

In a specific implementation, the operators after the fusion adopt compilation optimization methods such as memory reuse, memory access optimization, instruction pipelining, and data type optimization (for example, selection of different data types that may be applied) during compilation, thus significantly improving the overall performance of the operators after the fusion.

In view of this, the embodiment in the embodiment of this disclosure provides a scheme of performing an operator fusion on the view-class operator subgraph constructed based on the above method to optimize the operator subgraph and then optimize subsequent memory data contiguity processing.

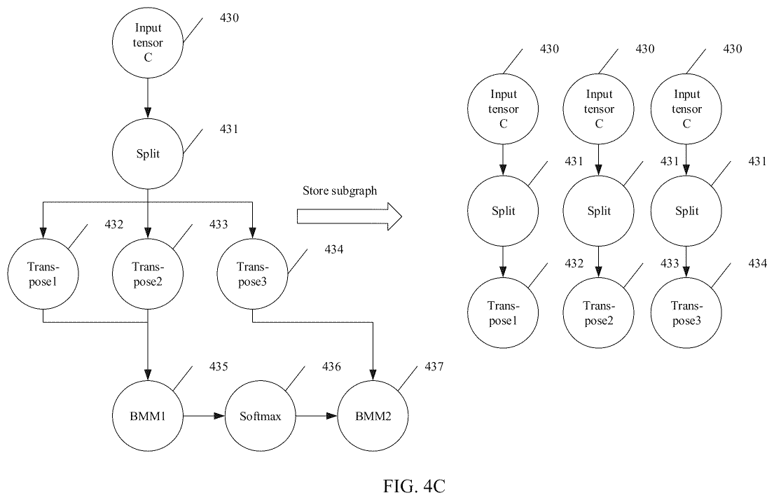

FIG. 6 shows an exemplary method flowchart of an operator fusion according to some embodiments of the present disclosure. In this embodiment, an operator fusion strategy is selected by scanning a pre-constructed view-class operator subgraph.

As shown in the figure, in step 610, a view-class operator subgraph of tensor data in a computing graph is acquired, where the view-class operator subgraph includes a view-class source operator associated with the tensor data.

The view-class operator subgraph is constructed according to the method described earlier, as shown by several examples in FIGS. 4A to 4C. It may be seen that an operator in the operator subgraph before optimization is an original view-class operator in the computing graph, which is called a source operator here to distinguish it from an operator after optimization.

Next, in step 620, the source operator is replaced with a target operator whose specified function is interchangeable with that of the source operator based on a function of the source operator in the view-class operator subgraph.

In programming frameworks such as Pytorch, there are various view-class operators to realize different functions. These operators include, for example, but are not limited to: transpose, permute, select, chunk, narrow, slice, expand, view, and so on.

Although specific functions realized by these operators are varied, they may also be classified. In some embodiments, the functions may be classified into scale reduction, scale expansion and scale invariance according to the effects of the functions realized by the operators on the scale of the data. For example, as far as the operators listed above are concerned, those such as transpose, permute, and view operators do not alter the scale of tensor data and belong to the scale-invariant class of operators: those such as select, chunk, narrow, and slice operators reduce the scale of tensor data and belong to the scale-reducing class of operators: whereas those such as expand operators extend the scale of tensor data and belong to the scale-expanding class of operators.

For each type of function, an operator may be selected to represent that type of function. This operator may realize functions of all operators in the corresponding function category. In other words, this operator may replace all operators in the corresponding function category in terms of function. In this paper, an operator after replacement is called a “target operator”, and an operator before replacement is called a “source operator”. The examples in Table 1 below show several types of function classification, as well as source and target operators included in each type of function. It may be understood that the operators here are illustrative rather than exhaustive, and those skilled in the art may construct similar function classifications and functionally replaceable target operators according to the principles in the embodiment of this disclosure.

TABLE 1

| Sequence number | Source operator name | Target operator name |
|---|---|---|
| 1. Scale invariance | Transpose, permute, view | permute |
| 2. Scale reduction | Select, chunk, narrow, slice | slice |
| 3. Scale expansion | expand | expand |

It may be seen that the functions realized by the source operators included in each type of function are subsets of corresponding target operators. By classifying these source operators according to their functions and replacing them with specified target operators, operator types in the operator subgraph may be reduced to facilitate subsequent fusion operations.

Continuing to FIG. 6, finally, in step 630, a plurality of contiguous identical target operators in the replaced operator subgraph are fused into a single target operator to generate a fused view-class operator subgraph.

By replacing in the previous step, view-class operators with similar functions are replaced into the same target operator. When a plurality of identical target operators are contiguous in position, these target operators may be fused into a single target operator, thus reducing the number of operators and then reducing the number of operators that need to be called later.

In some embodiments, fusing the plurality of contiguous identical target operators into the single target operator may include: merging dimension operations of the plurality of target operators, such that the single target operator after the fusion is equivalent to the plurality of target operators before the fusion.

It may be understood that under normal circumstances, the dimension operations of the plurality of contiguous target operators are performed sequentially, and each target operator performs dimension operations on its input tensor data in turn. Since the target operators are contiguous and identical, these dimension operations may be merged to achieve the effect of a plurality of dimension operations with a single target operator.

For example, it is assumed that there are two contiguous operators in the view-class operator subgraph, which are a chunk operator and a split operator, respectively. According to function classification, both the chunk operator and the split operator belong to the scale-reducing class of operators, so the slice operator is used here instead. According to the embodiment of this disclosure, these two slice operators may be merged into one slice operator, and dimension operations of these two slice operators need to be merged into one.

The first slice operator corresponds to the original chunk operator, and it is assumed that its dimension operation is to slice the dim0 of input tensor data D into two blocks. When the chunk operator is executed, the dim0 of the tensor data D is evenly sliced into two blocks as far as possible.

The second slice operator corresponds to the original split operator, and it is assumed that its dimension operation is to slice the dim1 of the input tensor data D into two blocks, where a size of each block is 4 as far as possible. When the split operator is executed, the dim1 of the tensor data D is sliced into blocks of size 4 as far as possible.

When these two slice operators are merged into one slice operator, its dimension operation to be implemented is to slice the dim0 of the input tensor data D into two blocks and the dim1 of the input tensor data D into blocks of size 4 as far as possible. The preceding operations may be implemented by configuring the computation parameters of the slice operator.

Optionally or additively, in some embodiments, it is also possible to adjust a position of a specific type of target operator in the view-class operator subgraph to optimize processing.

In an example, a position of an expand-class operator (such as the expand operator) that causes an increase in memory data may be postponed. This postponement processing may prevent an early increase in memory data and then an increased amount of data moving for subsequent IO operators. Preferably, the position of the expand-class operator is postponed as far as possible.

When the position of the expand-class operator is postponed, according to positions of the expand-class operator before and after the adjustment, parameters of target operators between the two positions in the view-class operator subgraph are required to be modified to adapt to this position adjustment

For example, it is assumed that the operator subgraph includes an expand operator, a permute operator, and a slice operator (it is assumed that all have been replaced into target operators) in turn. A dimension operation implemented by the expand operator is to expand a dimension size (for example, size1=(1, 3), representing a matrix with 1 row and 3 columns) of tensor data E into a new shape (for example, size2=(2, 3), representing a matrix with 2 rows and 3 columns, obtained by copying and expanding the tensor data E) to obtain tensor data E′; a dimension operation implemented by the permute operator is to swap and permute two pieces of dimension data of the tensor data E′ after expanding to obtain tensor data E″; and a dimension operation implemented by the slice operator is to slice the tensor data E″ into 2×2 blocks as far as possible, and take a first data block among them.

According to the embodiment of this disclosure, the expand operator may be adjusted to the very end, thereby requiring the modification of parameters of the permute and slice operators. According to the analysis, the expand operator increases a size of one of the dimensions (such as dim0) of the tensor data E, not the dimensions. Therefore, the parameters of the permute operator may be unchanged, for example, still being (1, 0), representing that dim0 is swapped with dim1. Because the expand operator changes the dimension size of the dim0, the parameters of the slice operator need to be adjusted. For example, if the dimension size is not changed, the original parameters may be maintained. If the dimension size is changed, the parameters need to be reduced correspondingly, for example, to ½ (based on the expansion multiple of the expand operator) of the original. In other words, the dimension operation of the slice operator is modified to slice the tensor data output by the permute operator into 2×1 blocks as far as possible, and take a first data block among them. Accordingly, the expand operator adjusted to the end also adjusts its parameters according to the situation. For example, the dimension size after expanding is adjusted to size3=(2, 2), so that the dimension operation after adjusting is equivalent to the dimension operation before adjusting.

After the above processing, the view-class operator subgraph after the fusion may be returned.

As mentioned earlier, when the tensor data becomes discontiguous in memory through the view-class operator, the traditional CPU and GPU need to perform discontiguous data access and read through the formula described above, which will lead to low memory access efficiency and high time consumption of hardware devices. In the neural network computing library, most operators need the input tensor to be contiguous in memory, otherwise there will be an error. In this case, an operator such as contiguous( ) is required to be called. This operator also moves data one piece by one piece into contiguous storage according to the above formula. This method of moving data one piece by one piece is very time-consuming, which brings great time overhead to the computation of the entire computing graph.

In some embodiments of this disclosure, after the view-class operator subgraph is constructed and selectively fused and optimized, when an operator (such as a computation-class operator) that requires tensor data to be contiguous in memory is encountered, based on these pre-constructed view-class operator subgraphs, memory data contiguity processing may be performed, and a corresponding kernel may be called for data moving, thus reducing the time of data moving and improving computing efficiency.

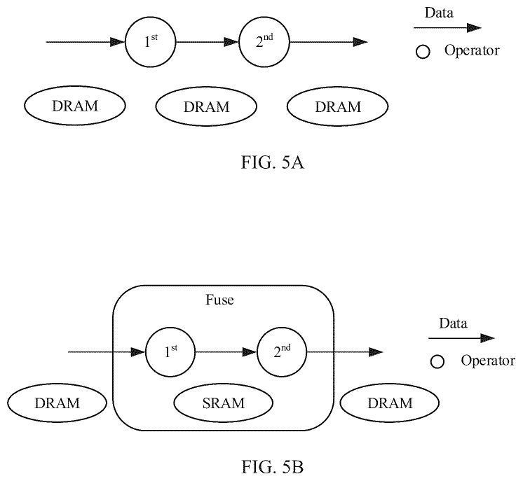

FIG. 7 shows an exemplary flowchart of a data processing method according to some embodiments of the present disclosure.

As shown in the figure, in step 710, a view-class operator subgraph of to-be-processed tensor data is acquired in response to the tensor data being discontiguous in memory. The view-class operator subgraph of the tensor data is thus constructed and selectively optimized according to the method described above.

In some embodiments, an is_contiguous function may be used to determine whether the tensor data is contiguous in memory. If the tensor data is contiguous, no additional processing is required. If the tensor data is discontiguous, the view-class operator subgraph associated with the tensor data may be acquired.

It may be understood that if there is no view-class operator subgraph associated with the tensor data, the data may be moved one piece by one piece according to the existing method, for example, by calling the contiguous function, to make the tensor data become contiguous.

Then, in step 720, a corresponding kernel is called to perform data moving according to information of the acquired view-class operator subgraph to convert the tensor data into tensor data that is contiguous in memory.

Specifically, in order to avoid the time overhead caused by data moving one piece by one piece, operator types in the view-class operator subgraph may be analyzed and kernels matching the operator types may be called to perform data moving, where these kernels move the data by block according to the operator types.

As mentioned in the previous operator fusion, there are basically three types of view-class operators possible in the fused view-class operator subgraph: permute, slice, and expand. For each type of view-class operator, a suitable kernel may be selected from a high performance computing library to perform corresponding data moving. The kernel may realize a function of a corresponding operator. For example, for the permute operator, a transpose kernel in the high performance computing library (such as CNNL) may be called to realize a data rearrangement function. For example, for the expand operator, an expand kennel in the CNNL may be called to realize a data expansion function.

Therefore, according to the order of the view-class operator subgraph, each view-class operator is traversed for the call of the kernel, so that the tensor data converts from a memory discontiguous state into a memory contiguous state.

Compared with the previous data moving one piece by one piece, calling the kernel to move the data by block may greatly shorten the processing time and improve the memory access efficiency.

In some embodiments of this disclosure, a data processing scheme is proposed to reversely deduce a view-class operator that causes tensor data to be in a memory discontiguous state, thereby calling a suitable data moving operator to perform contiguous data moving based on the tensor, thus improving the processing speed.

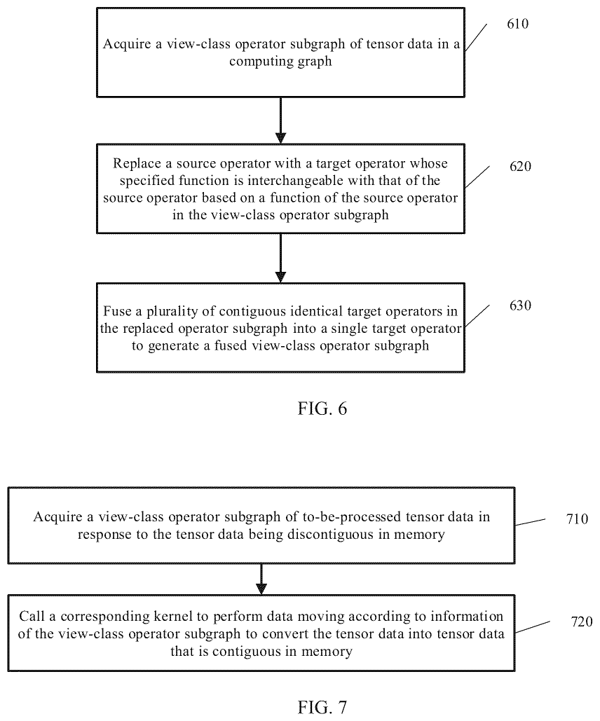

FIG. 8 shows an exemplary flowchart of a data processing method according to some embodiment of the present disclosure. In this processing method, by reversely deducing a view-class operator experienced by tensor data in a memory discontiguous state, a suitable data moving operator is selected from a computing library to perform contiguous data moving based on the tensor, thus acquiring tensor data in a memory contiguous state.

As shown in the figure, in step 810, a view-class operator through which a to-be-processed first tensor converts from a memory contiguous state into a memory discontiguous state is determined according to first description information of the first tensor in response to the first tensor being in the memory discontiguous state.

In some embodiments, whether the tensor data is contiguous in memory may be determined by, for example, an is_contiguous function in a Pytorch framework, manual computations, and other methods, which is not limited in the present disclosure. If the tensor data is contiguous, no additional processing is required. If the tensor data is discontiguous, reverse deduction may be performed on the tensor data.

The description information of the tensor data may include the three properties mentioned earlier: shape (size), stride, and storage offset (storage_offset). The shape represents a multidimensional view presented by data elements in tensor data in whole, and the stride and the storage_offset may determine specific positions of data elements in memory. The view-class operator changes these properties of the tensor data, so the view-class operator experienced by the tensor data may be reversely deduced from these properties. Each type of view-class operator has different properties. Based on these properties, and depending on the property change of the tensor data, it may be determined which view-class operator causes this change in the property of the tensor data.

Specifically, in some embodiments, the view-class operator experienced by the first tensor may be determined based on first data shape information (size) and first dimension stride information (stride) in the first description information.

For example, rearrangement view-class operators such as transpose, permute, view operators, do not change a data size of the tensor data, but change relative positions of data elements in the window. Therefore, based on this property, when the rearrangement view-class operator is applied to the tensor data, a data size indicated by data shape information of the tensor data remains unchanged, which is consistent with a memory size to which the tensor data before processing is directed. However, because the relative positions of the data elements such as the dimension order change, the dimension stride information is no longer arranged in a descending order in a contiguous state.

According to this property change of the tensor data, in some examples, it may be determined whether the view-class operator experienced by the first tensor is a rearrangement view-class operator by judging whether the following conditions are met, namely: the data size indicated by the first data shape information of the first tensor is consistent with the memory size to which the first tensor is directed, and the first dimension stride information indicates that each dimension stride is arranged in a non-descending order.

For example, the expand operator, which is an expansion view-class operator, will expand the data size of the tensor data. However, since this operator does not copy the data stored in the tensor, but takes the data repeatedly in the same position, there is a dimension stride with a 0 value in the dimension stride information of the tensor data that has experienced the expand operator. In other words, when the data of this dimension is taken, the move stride is 0. Therefore, based on this property, conditions may be established to determine whether the tensor data has experienced the expansion view-class operator.

Specifically, in some examples, it may be determined whether the view-class operator experienced by the first tensor is the expansion view-class operator by judging whether the following conditions are met, namely: there is a dimension stride with a 0 value in the first dimension stride information of the first tensor, and the data size obtained by adjusting the first data shape information according to the position index of the 0 value is consistent with the memory size to which the first tensor is directed. The above judging process is described later with specific examples.

After the view-class operator experienced by the first tensor is determined, then, in step 820, a data moving operator in a computing library that needs to be called is determined according to the determined view-class operator.

There are many operators in the high performance computing library, which are used to realize different functions, such as IO, computation, and so on. There are some data moving operators in the computing library, which may perform contiguous data moving based on the tensor, thus improving processing efficiency. For example, a CNNL permute/transpose operator transposes the tensor data: a CNNL expand operator expands the tensor data, and so on. These operators may realize functions corresponding to similar operators in the programming framework, and the difference is that these operators will change the actual position of the data in memory; in other words, the data will be moved in memory.

Therefore, by analyzing what kind of view-class operators that the tensor data may experience, a data moving operator with a corresponding function may be selected to realize the memory contiguity processing of the data.

Specifically, in some embodiments, when the determined view-class operator is a rearrangement view-class operator, the data moving operator that needs to be called is determined to be a data rearrangement operator, such as a CNNL transpose operator.

Optionally or additively, in some embodiments, when the determined view-class operator is an expansion view-class operator, the data moving operator that needs to be called is determined to be a data expansion operator, such as a CNNL expand operator.

Then, in step 830, a parameter required for calling the data moving operator to convert the first tensor from the memory discontiguous state into the memory contiguous state is determined according to the first description information of the first tensor.

As mentioned earlier, most operators in the high performance computing library require the input tensor to be contiguous in memory, including the data moving operators mentioned above that perform contiguous data moving based on the tensor. Therefore, when these data moving operators are called, corresponding parameters need to be determined. These parameters include: second description information of a second tensor serving as an input tensor of the data moving operator, and parameter information of the data moving operator. It may be understood that an output tensor of the data moving operator is a tensor that has the same shape as the first tensor processed, but is in the memory contiguous state.

As the input tensor of the data moving operator, the second tensor must be contiguous in memory, so it is necessary to deduce the description information of the data on the current memory when it is in the memory contiguous state according to the first description information of the current first tensor, which means that to deduce the second description information of the second tensor. According to the characteristics of the view-class operator that causes the first tensor to convert from the memory contiguous state into the memory discontiguous state, it is possible to reversely deduce the description information of the data in memory corresponding to the first tensor when it is in the memory contiguous state.

In an example, when the data moving operator is a data rearrangement operator (which means that the view-class operator is a rearrangement view-class operator), the second description information of the second tensor serving as the input tensor of the data moving operator may be determined in the following way: the descending arrangement of the first dimension stride information in the first description information is first determined as second dimension stride information in the second description information of the second tensor; and then according to the rule of converting the first dimension stride information into the descending arrangement, the first data shape information in the first description information is converted, thus obtaining second data shape information in the second description information.

In another example, when the data moving operator is a data expansion operator (which means that the view-class operator is an expansion view-class operator), the second description information of the second tensor serving as the input tensor of the data moving operator may be determined in the following way: a position index corresponding to a 0 value is first obtained from the first dimension stride information in the first description information; and then according to the position index of the 0 value, a corresponding position of the first data shape information in the first description information is set to 1 to determine the second data shape information in the second description information; and according to the second data shape information and the memory contiguity rule, the second dimension stride information in the second description information is determined. The above parameter determination methods are described in detail later with examples.

After the input tensor (the second tensor) of the data moving operator is determined and the shape (the first data shape information of the first tensor) of the output tensor is known, the computation parameter information of the data moving operator may be determined accordingly. Depending on different data moving operators, their corresponding computation parameter information is determined in different ways.

In an example, when the data moving operator is a data rearrangement operator, determining the computation parameter information of the data moving operator may include: taking the second tensor as the input of the data moving operator; taking the first tensor as the output of the data moving operator, and deducing the computation parameter information of the data moving operator based on the first description information and the second description information.

In another example, when the data moving operator is a data expansion operator, determining the computation parameter information of the data moving operator may include: taking the first data shape information as the computation parameter information.

Therefore, the data moving operator required to be called and its parameters are determined.

Finally, in step 840, the data moving operator is called according to the determined parameter to convert the state of the first tensor into the memory contiguous state. In this step, the data moving operator is performed to move the data in the memory. Since these data moving operators perform contiguous moving based on the tensor, they may greatly improve the data moving efficiency compared with moving the data one piece by one piece.

The application in the embodiment of this disclosure is described below in conjunction with several specific examples.

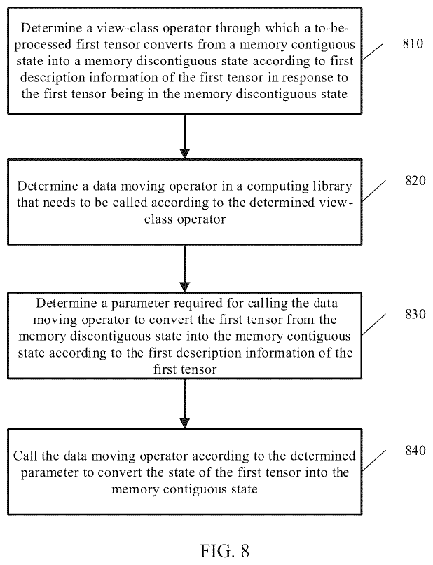

FIG. 9 shows an exemplary flowchart of a data processing method according to an embodiment of the present disclosure.

As shown in the figure, first of all, in step 910, it is judged whether tensor data currently processed is in a memory contiguous state, for example, through an is_contiguous function under a Pytorch framework. If the tensor data is contiguous, no processing is required (step 950). If the tensor data is discontiguous, this process proceeds to step 920 to make further conditional judgments, so as to determine whether a view-class operator that causes the tensor data to be discontiguous is a rearrangement view-class operator.

In this example, it is assumed that current tensor data is c, its shape is: c₄=(4,6,5,3), and its dimension stride is S_{c}=(30,1,6,120). Through the is_contiguous function, it is easy to determine that the tensor data c is in a memory discontiguous state.

Next, in step 920, it is judged whether the conditions for the rearrangement view-class operator are met. Specifically, it is first judged whether a data size of the current tensor data c is as large as a memory address space to which the tensor data c is directed (step 921). If the data size of the current tensor data c is not as large as the memory address space to which the tensor data c is directed, it means that the tensor data c does not experience the rearrangement view-class operator, and it is then judged whether the conditions for other view-class operators are met (step 960), such as the conditions for the expansion view-class operator described in conjunction with 10 below. If the data size of the current tensor data c is as large as the memory address space to which the tensor data c is directed, it means that the tensor data may experience the rearrangement view-class operator.

Continuing with the previous example, it is assumed that the memory address space to which the tensor data c is directed is 360. Based on the shape information c₄=(4,6,5,3) of the tensor data c, the data size of the tensor data c may be computed to be 4×6×5×3=360, which is consistent with the size of the memory address space.

When the data size of the tensor data c is as large as the memory address space, it may be further judged whether a dimension stride of the current tensor data c is arranged in a descending order (step 922). If the dimension stride of the current tensor data c is arranged in a descending order, it means that the tensor data c is contiguous in memory, and no processing is required (step 950). If the dimension stride of the current tensor data c is arranged in a non-descending order, it is determined that the tensor data c experiences the rearrangement view-class operator.

Therefore, a data rearrangement operator (such as a CNNL transpose operator) in a computing library may be called to perform data moving on the tensor data c to convert the state of the tensor data c into the memory contiguous state.

Next, in step 930, parameters required for calling a data rearrangement operator are deduced, including description information of an input tensor, and computation parameter information.

Specifically, in step 931, dimension stride information of the tensor data c is arranged in a descending order to deduce corresponding dimension stride information of the tensor data c when it is in the memory contiguous state, which is also to be the dimension stride information of the input tensor (assumed to be tensor data a) of the data rearrangement operator. For example, the dimension stride of the tensor data c is S_{c}=(30,1,6,120), and its corresponding descending arrangement is Sₐ=(120,30,6,1), which is also the dimension stride information of the input tensor a.

Then, in step 932, a shape of the tensor data c is converted according to a rule of converting the dimension stride S_{c} of the tensor data c into the dimension stride Sₐ of the tensor data a to obtain shape information of the tensor data a, which means that data shape information.

In the above example, if the dimension stride S_{c} of the tensor data c is identified as (0,1,2,3) in order, then the dimension stride Sₐ of the tensor data a is identified as (3,0,2,1), which means that the relative position of the dimension is changed from (0,1,2,3) to (3,0,2,1). According to this change rule, the shape c₄=(4,6,5,3) of the tensor data c is similarly converted, and the shape a₄=(3,4,5,6) of the tensor data a is then obtained.

Thus, the data shape information and the dimension stride information in the description information of the tensor data a may be determined.

Then, in step 933, the tensor data a is taken as an input tensor of the data rearrangement operator, the shape of the tensor data c is taken as an output tensor of the data rearrangement operator, and computation parameter information for calling the data rearrangement operator is determined according to description information of the input and the output.

In the current example, to convert the tensor data a of shape a₄=(3,4,5,6) into the output tensor of shape c₄=(4,6,5,3), the computation parameters (axis parameters) of the corresponding data rearrangement operator may be determined as (1,3,2,0). In other words, if the dimension order of the tensor data a is identified as (0,1,2,3), then after rearrangement, the dimension order of the output tensor should become (1,3,2,0) to correspond to this shape c₄=(4,6,5,3) of the output tensor.

Finally, in step 940, the data rearrangement operator is called, and the input tensor (the tensor data a) is rearranged according to computation parameters (1,3,2,0) to obtain an output tensor, whose shape is the same as that of the tensor data c to be processed initially, but which is already in a contiguous state in memory.

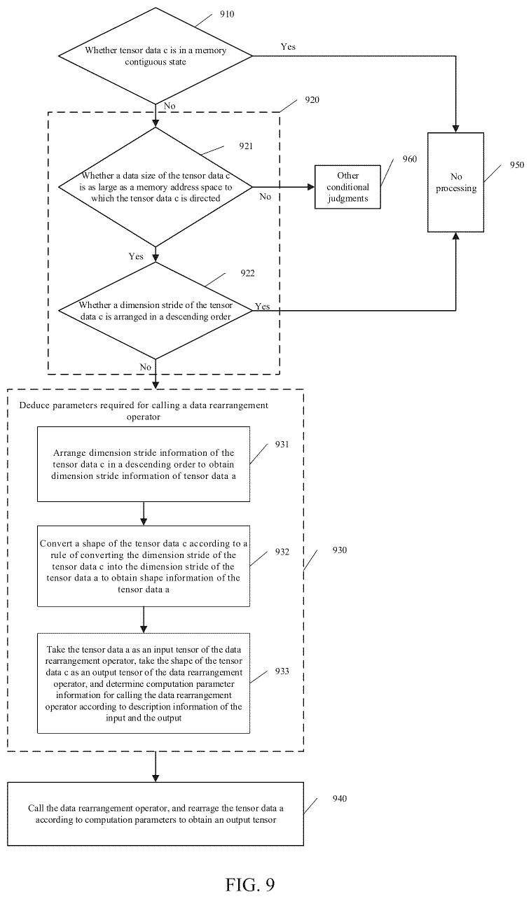

FIG. 10 shows an exemplary flowchart of a data processing method according to another embodiment of the present disclosure.

As shown in the figure, first of all, in step 1010, whether tensor data b currently processed is in a memory contiguous state is judged, for example, through an is_contiguous function under a Pytorch framework. If the tensor data b is contiguous, no processing is required (step 1050). If the tensor data b is discontiguous, this process proceeds to step 1020 to make further conditional judgments, so as to determine whether a view-class operator that causes the tensor data to be discontiguous is an expansion view-class operator.

In this example, it is assumed that current tensor data is b, its shape is: b₅=(3,2,5,3,7), and its dimension stride is S_{b}=(35,0,7,0,1). Through the is_contiguous function, it is easy to determine that the tensor data b is in a memory discontiguous state.

Next, in step 1020, it is judged whether the conditions for the expansion view-class operator are met. Specifically, it is first judged whether there is a dimension stride with a 0 value in the dimension stride of the current tensor data b (step 1021). If there is no dimension stride with a 0 value in the dimension stride of the current tensor data b, it means that the tensor data b has not experienced the expansion view-class operator, and it is further judged whether the conditions for other view-class operators are met (step 1060), such as the conditions for the rearrangement view-class operator described in FIG. 9. If there is a dimension stride with a 0 value in the dimension stride of the current tensor data b, it means that there are dimensions obtained by expansion in the tensor data b: in other words, the tensor data b has experienced the expansion view-class operator.

At this point, it may be further judged whether the tensor data b is in the memory contiguous state before experiencing the expansion view-class operator. Specifically, the size of the corresponding dimension in the data shape information of the tensor data b may be set to 1 according to the position index of the 0 value; in other words, the expansion is removed, and then it is judged whether the data size obtained is as large as a memory size to which the tensor data b is directed (step 1022). If the data size obtained is not consistent with the memory size to which the tensor data b is directed, it means that the tensor data b is not in the memory contiguous state before experiencing the expansion view-class operator. At this time, it is further judged whether the conditions for other view-class operators are met (step 1060), or memory contiguity processing is performed in the way mentioned in the background (not shown in the figure). If the data size obtained is consistent with the memory size to which the tensor data b is directed, it means that the tensor data experiences the expansion view-class operator, and the tensor data is in the memory contiguous state before experiencing the expansion view-class operator.

Continuing with the previous example, it is assumed that the memory address space to which the tensor data b is directed is 105. Based on the dimension stride information S_{b}=(35,0,7,0,1) of the tensor data b, it may be seen that two of the dimensions are obtained by expansion, which are dim1 and dim3. The expansion of the corresponding dimension is removed, which means that the corresponding dimension size is set to 1, and then the shape before expansion may be obtained, which is (3,1,5,1,7), according to the shape information b₅=(3,2,5,3,7) of the tensor data b. According to this shape, the data size may be computed to be 3×1×5×1×7=105, which is consistent with the size of the memory address space.

Therefore, a data expansion operator (such as a CNNL expand operator) in a computing library may be called to perform data moving on the tensor data b to convert the state of the tensor data b into the memory contiguous state.

Next, in step 1030, parameters required for calling a data expansion operator are deduced, including description information of an input tensor, and computation parameter information.

Specifically, in step 1031, a corresponding position of data shape information of the tensor data b is set as 1 according to a position index of the 0 value in the dimension stride information of the tensor data b to obtain data shape information of an input tensor. It may be understood that the shape after removing the expansion is the data shape before the expansion, which means that the shape of the input tensor of the data expansion operator.

In this example, the dimension stride information of the tensor data b is S_{b}=(35,0,7,0,1), where both the strides of dim1 and dim3 are 0 values. Accordingly, dim1 and dim3 in the shape information b₅=(3,2,5,3,7) of the tensor data b are reset to 1 to obtain the shape (3,1,5,1,7) before expansion, which is the shape of the current data in memory when it is in the contiguous state.

Then, in step 1032, corresponding dimension stride information, which means that dimension stride information of the input tensor, is determined according to the deduced shape before expansion and a memory contiguity rule.

In this example, based on the deduced shape (3,1,5,1,7), following the principle of memory contiguity, the dimension stride may be determined to be (35,35,7,7,1), which is also to be the dimension stride information of the input tensor of the data expansion operator.

From this, the data shape information and the dimension stride information in the description information of the input tensor of the data expansion operator may be determined.

Then, in step 1033, computation parameter information of the data expansion operator is determined. It may be understood that the data expansion operator needs to expand the input tensor into the same shape as the tensor data b that is currently in the memory discontiguous state, so its computation parameter information is the data shape information of the tensor data b. In this example, the computation parameter information is (3,2,5,3,7), which means that dim1 is required to be expanded into two parts and dim3 is required to be expanded into three parts.

Finally, in step 1040, the data expansion operator is called, and the data expansion is applied according to computation parameters (3,2,5,3,7) for the input tensor (the shape is (3,1,5,1,7), and the dimension stride is (35,35,7,7,1)) to obtain an output tensor, whose shape is consistent with that of the data tensor b to be processed initially, but which is already in a contiguous state in memory, which means that the substantial data replication expansion is performed.

The above, in combination with the attached figure, describes the construction method of the view-class operator subgraph, the optimization method of the operator fusion, and the memory data contiguity processing method based on the view-class operator subgraph or derivation in the embodiment of this disclosure. This disclosure also provides a computing apparatus that may be configured to construct a view-class operator subgraph, optimize an operator subgraph, or perform memory data contiguity processing.

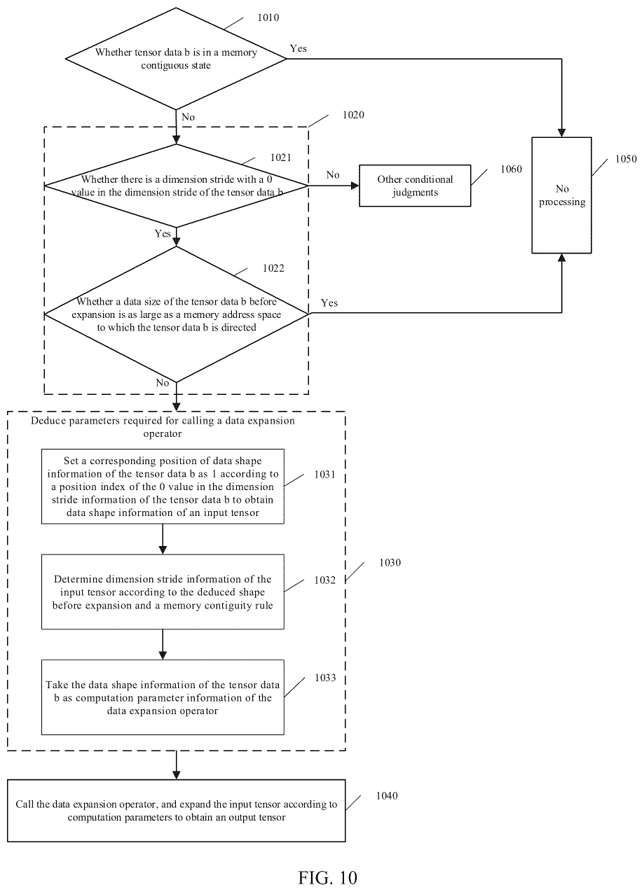

FIG. 11 shows a block diagram of a hard configuration of a computing apparatus 1100 that may implement various schemes in the embodiment of this disclosure. As shown in the figure, the computing apparatus 1100 may include a processor 1110 and a storage 1120. In the computing apparatus 1100 of FIG. 11, components relevant to this embodiment are shown. Therefore, it is obvious to those skilled in the art that the computing apparatus 1100 may further include common components that differ from those shown in FIG. 8, such as a display.

The computing apparatus 1100 may correspond to a computing device with various processing functions such as a function for compiling a computing graph. For example, the computing apparatus 1100 may be implemented as various types of devices, such as a PC (personal computer), a server device, a mobile device, and the like.

The processor 1110 is configured to perform a program instruction to control all functions of the computing apparatus 1100. For example, the processor 1110 performs a program stored in the storage 1120 of the computing apparatus 1100 to control all functions of the computing apparatus 1100. The processor 1110 may be implemented by a CPU, a GPU, an AP (application processor), an IPU (intelligence processor chip), and the like, provided in the computing apparatus 1100. However, the present disclosure does not limit this.

The storage 1120 is configured to store hardware of various data processed in the computing apparatus 1100. For example, the storage 1120 stores data processed and to be processed in the computing apparatus 1100. The storage 1120 may store data that the processor 1110 has processed or is to process, such as a computing graph before compilation, a computing graph after compilation, and the like. Additionally, the storage 1120 may store program instructions such as applications and driver programs to be driven by the computing apparatus 1100. For example, the storage 1120 may store various programs related to optimization algorithms of computing graphs to be executed by processor 1110. The storage 1120 may be a DRAM, which is not limited in the present disclosure. The storage 1120 may include at least one of a volatile memory or a nonvolatile memory. The nonvolatile memory may include an ROM (read only memory), a PROM (programmable ROM), an EPROM (electrically PROM), an EEPROM (electrically erasable PROM), a flash memory, a PRAM (phase-change RAM), an MRAM (magnetic RAM), an RRAM (resistive RAM), an FRAM (ferroelectric RAM), and the like. The volatile memory may include a DRAM, an SRAM (static RAM), an SDRAM (synchronous DRAM), the PRAM, the MRAM, the RRAM, the FRAM, and the like. In this embodiment, the storage 1120 may include at least one of an HDD (hard disk drive), an SSD (solid state drive), a CF (compact flash), an SD (secure digital) card, a Micro-SD card, a Mini-SD card, a limit digital (xD) card, a cache, or a memory stick.

In short, specific functions realized by the storage 1120 and the processor 1110 in the computing apparatus 1100 provided by the embodiment of this specification may be interpreted in contrast to the foregoing embodiments in this specification and may achieve the technical effects of the above-mentioned embodiments, which will not be repeated herein.

The embodiment of the present disclosure also provides a computer readable storage medium, on which a program instruction is stored, where when the program instruction is loaded and performed by a processor, the processor performs the computing graph optimization method or the data processing method described in the embodiment of the present disclosure.

The embodiment of the present disclosure also provides a computer program product, including a computer program or instruction, where when the computer program or instruction is performed by a processor, the computing graph optimization method or the data processing method described in the embodiment of the present disclosure is implemented.

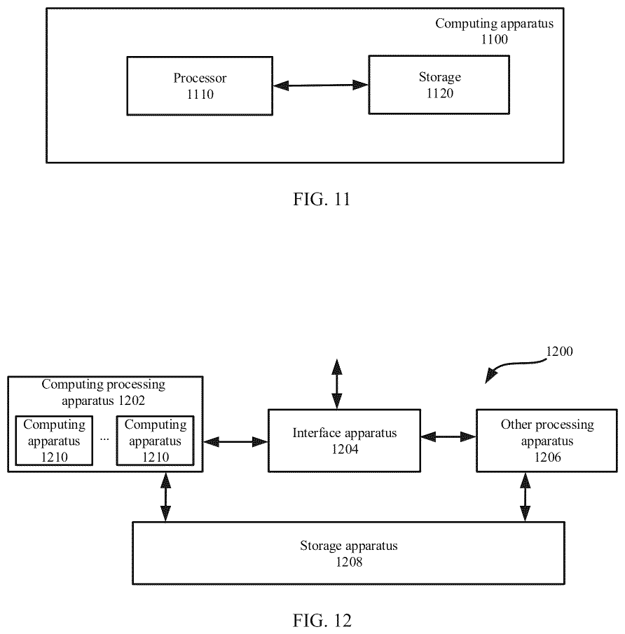

FIG. 12 is a structural diagram of a combined processing apparatus 1200 according to an embodiment of the present disclosure. As shown in the figure, the combined processing apparatus 1200 includes a computing processing apparatus 1202, an interface apparatus 1204, other processing apparatus 1206, and a storage apparatus 1208. According to different application scenarios, the computing processing apparatus may include one or a plurality of computing apparatuses 1210, which may be configured as the computing apparatus 1100 shown in FIG. 11, for performing operations described herein in combination with drawings.

In different embodiments, the computing processing apparatus of the present disclosure may be configured to perform an operation specified by a user. In an exemplary application, the computing processing apparatus may be implemented as a single-core artificial intelligence processor or a multi-core artificial intelligence processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having a single-core structure or an isomorphic multi-core structure.

In an exemplary operation, the computing processing apparatus of the present disclosure may interact with other processing apparatus through the interface apparatus, so as to jointly complete the operation specified by the user. According to different implementations, other processing apparatuses of the present disclosure may include one or more types of general and/or dedicated processors, including a CPU, a GPU, an artificial intelligence processor, and the like. These processors include but are not limited to a DSP (digital signal processor), an ASIC (application specific integrated circuit), an FPGA (field-programmable gate array), or other programmable logic components, discrete gate or transistor logic components, discrete hardware components, and the like. Moreover, the number of the processors may be determined according to actual requirements. As described above, with respect to the computing processing apparatus of the present disclosure only, the computing processing apparatus of the present disclosure may be regarded as having the single-core structure or the isomorphic multi-core structure. However, when the computing processing apparatus and other processing apparatus are considered together, both the computing processing apparatus and other processing apparatus may be regarded as forming a heterogeneous multi-core structure.

In one or a plurality of embodiments, other processing apparatus may serve as an interface between the computing processing apparatus (which may be embodied as an artificial intelligence operation apparatus such as a neural network operation apparatus) of the present disclosure and external data and controls. Other processing apparatus may perform basic controls that include but are not limited to moving data, and starting and/or stopping the computing apparatus. In other embodiments, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may acquire input data from other processing apparatus via the interface apparatus and write the input data to an on-chip storage apparatus (or called a storage) of the computing processing apparatus. Further, the computing processing apparatus may acquire the control instruction from other processing apparatus via the interface apparatus and write the control instruction to an on-chip control cache of the computing processing apparatus. Alternatively or optionally, the interface apparatus may further read data in the storage apparatus of the computing processing apparatus and then transfer the data to other processing apparatus.

Additionally or optionally, the combined processing apparatus of the present disclosure may further include a storage apparatus. As shown in the figure, the storage apparatus is connected to the computing processing apparatus and other processing apparatus, respectively. In one or a plurality of embodiments, the storage apparatus may be used to save data of the computing processing apparatus and/or other processing apparatus. For example, the data may be data that may not be fully saved in the internal or the on-chip storage apparatus of the computing processing apparatus or other processing apparatus.

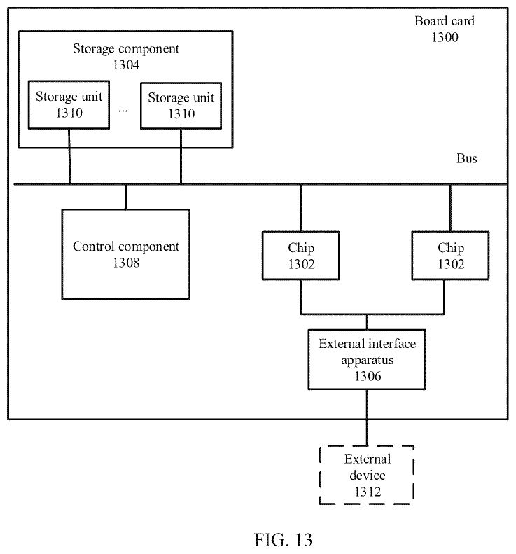

In some embodiments, the present disclosure also discloses a chip (such as a chip 1302 shown in FIG. 13). In an embodiment, the chip is an SoC (system on chip) and integrates one or a plurality of combined processing apparatuses shown in FIG. 12. The chip may be connected to other related components through an external interface apparatus (such as an external interface apparatus 1306 shown in FIG. 13). The related components may be, for example, a camera, a monitor, a mouse, a keyboard, a network card, or a WIFI interface. In some application scenarios, the chip may integrate other processing units (such as a video codec) and/or an interface unit (such as a DRAM interface), and the like. In some embodiments, the present disclosure also discloses a chip package structure, including the chip. In some embodiments, the present disclosure discloses a board card, including the chip package structure. The board card will be described in detail in combination with FIG. 13 below.

FIG. 13 is a schematic structural diagram of a board card 1300 according to an embodiment of the present disclosure. As shown in the figure, the board card includes a storage component 1304 configured to store data. The storage component 1304 includes one or a plurality of storage units 1310. The storage component may connect to and transfer data to a control component 1308 and the aforementioned chip 1302 through a bus. Further, the board card further includes an external interface apparatus 1306, which is configured to implement data relay or transfer between the chip (or the chip in the chip package structure) and an external device 1312 (such as a server or a computer, and the like). For example, to-be-processed data may be transferred from the external device to the chip through the external interface apparatus. For another example, a computing result of the chip may still be sent back to the external device through the external interface apparatus. According to different application scenarios, the external interface apparatus may have different interface forms. For example, the external interface apparatus may adopt a standard PCIe (peripheral component interface express) interface.

In one or a plurality of embodiments, the control component in the board card of the present disclosure may be configured to regulate and control a state of the chip. As such, in an application scenario, the control component may include an MCU (micro controller unit), which may be used to regulate and control a working state of the chip.

According to descriptions in combination with FIG. 12 and FIG. 13, those skilled in the art may understand that the present disclosure also discloses an electronic device or apparatus. The electronic device or apparatus may include one or a plurality of the board cards, one or a plurality of the chips, and/or one or a plurality of the combined processing apparatuses.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood, and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments: in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. With respect to a connection between different units or components, the connection discussed above in combination with drawings may be direct or indirect coupling between the units or components. In some scenarios, the direct or indirect coupling involves a communication connection using an interface. The communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a CPU, a GPU, an FPGA, a DSP, and an ASIC, and the like. Further, the storage unit or the storage apparatus may be any appropriate storage medium (including a magnetic storage medium or a magneto-optical storage medium), such as an RRAM, a DRAM, an SRAM, an EDRAM (enhanced dynamic random access memory), an HBM (high bandwidth memory), an HMC (hybrid memory cube), an ROM, and an RAM, and the like.

The foregoing may be better understood according to following articles.

Article 1. A computing graph optimization method, including: traversing an operator associated with tensor data in a computing graph; and extracting the operator to construct a view-class operator subgraph when the operator is a view-class operator, where the view-class operator subgraph is used to perform memory data contiguity processing.

Article 2. The method of article 1, where extracting the operator to construct the view-class operator subgraph includes: associatively caching operator information and an operator sequence number of the operator, and adding the operator sequence number to the view-class operator subgraph.

Article 3. The method of article 2, where extracting the operator to construct the view-class operator subgraph further includes: checking whether the operator information of the operator has been cached: generating the operator sequence number for the operator and performing the caching and adding if the operator information of the operator is not cached; and adding the operator sequence number of the operator, which has been cached, to the view-class operator subgraph if the operator information of the operator has been cached.

Article 4. The method of article 2 or 3, where the operator information of the operator includes at least one of followings: description information of input data of the operator, description information of output data of the operator, and computation parameters of the operator.

Article 5. The method of any one of articles 1-4, where extracting the operator to construct the view-class operator subgraph further includes: when the operator is a multi-branch operator, constructing a view-class operator subgraph with a corresponding number of branches based on the multi-branch operator.

Article 6. A computing graph optimization method, including: acquiring a view-class operator subgraph of tensor data in a computing graph, where the view-class operator subgraph includes a view-class source operator associated with the tensor data: replacing the source operator with a target operator whose specified function is interchangeable with that of the source operator according to a function of the source operator in the view-class operator subgraph; and fusing a plurality of contiguous identical target operators into a single target operator to generate a fused view-class operator subgraph.

Article 7. The method of article 6, where fusing the plurality of contiguous identical target operators into the single target operator includes: merging dimension operations of the plurality of target operators, such that the single target operator after the fusion is equivalent to the plurality of target operators before the fusion.

Article 8. The method of article 6 or 7, further including: adjusting a position of a specific type of target operator for postponement processing after the fusion is performed, where the specific type of target operator is an expand-class operator that causes an increase in memory data.

Article 9. The method of article 8, where adjusting the position of the specific type of target operator for the postponement processing includes: according to positions of the specific type of target operator before and after the adjustment, modifying parameters of target operators between the two positions in the view-class operator subgraph to adapt to the adjustment.

Article 10. The method of any one of articles 6-9, where the function of the source operator is classified into scale reduction, scale expansion, and scale invariance according to the effect of the function on the scale of the memory data.

Article 11. The method of article 10, where target operators corresponding to the scale reduction, the scale expansion, and the scale invariance are respectively a slice operator, an expand operator, and a permute operator.

Article 12. A data processing method, including: acquiring a view-class operator subgraph of to-be-processed tensor data in response to the tensor data being discontiguous in memory, where the view-class operator subgraph is constructed or generated according to the method as described in any one of articles 1-11; and calling a corresponding kernel to perform data moving according to information of the view-class operator subgraph to convert the tensor data into tensor data that is contiguous in memory.

Article 13. The method of article 12, where calling the corresponding kernel to perform the data moving includes: analyzing operator types in the view-class operator subgraph, and calling kernels matching the operator types to perform data moving, where the kernels move the data by block according to the operator types.

Article 14. A data processing method, including: determining a view-class operator through which a to-be-processed first tensor converts from a memory contiguous state into a memory discontiguous state according to first description information of the first tensor in response to the first tensor being in the memory discontiguous state; determining a data moving operator in a computing library that needs to be called according to the view-class operator; determining a parameter required for calling the data moving operator to convert the first tensor from the memory discontiguous state into the memory contiguous state according to the first description information; and calling the data moving operator according to the parameter to convert the first tensor into the memory contiguous state.

Article 15. The method of article 14, where determining the view-class operator experienced by the first tensor includes: determining the view-class operator experienced by the first tensor according to first data shape information and first dimension stride information in the first description information.

Article 16. The method of article 15, where determining the view-class operator experienced by the first tensor further includes: determining the view-class operator experienced by the first tensor to be a rearrangement view-class operator when a data size indicated by the first data shape information is consistent with a memory size to which the first tensor is directed, and the first dimension stride information indicates that each dimension stride is arranged in a non-descending order.

Article 17. The method of article 15 or 16, where determining the view-class operator experienced by the first tensor further includes: determining the view-class operator experienced by the first tensor to be an expansion view-class operator when there is a dimension stride with a 0 value in the first dimension stride information, and a data size obtained by adjusting the first data shape information according to a position index of the 0 value is consistent with the memory size to which the tensor data is directed.

Article 18. The method of any one of articles 14-17, where determining the data moving operator that needs to be called according to the view-class operator includes: determining the data moving operator that needs to be called to be a data rearrangement operator when the view-class operator is a rearrangement view-class operator; or determining the data moving operator that needs to be called to be a data expansion operator when the view-class operator is an expansion view-class operator.

Article 19. The method of any one of articles 14-18, where determining the parameter required for calling the data moving operator includes: determining second description information of a second tensor serving as an input tensor of the data moving operator; and determining computation parameter information of the data moving operator.

Article 20. The method of article 19, where when the data moving operator is the data rearrangement operator, determining the second description information of the second tensor includes: determining a descending arrangement of the first dimension stride information in the first description information as second dimension stride information in the second description information of the second tensor; and converting the first data shape information in the first description information according to a rule of converting the first dimension stride information into the descending arrangement to obtain second data shape information in the second description information.

Article 21. The method of article 19, where when the data moving operator is the data expansion operator, determining the second description information of the second tensor includes: acquiring the position index of the 0 value from the first dimension stride information in the first description information: setting a corresponding position of the first data shape information in the first description information to 1 according to the position index of the 0 value to determine second data shape information in the second description information; and determining second dimension stride information in the second description information according to the second data shape information and a memory contiguity rule.

Article 22. The method of any one of articles 19-21, where when the data moving operator is the data rearrangement operator, determining the computation parameter information of the data moving operator includes: taking the second tensor as an input of the data moving operator: taking the first tensor as an output of the data moving operator; and deducing the computation parameter information of the data moving operator based on the first description information and the second description information.

Article 23. The method of any one of articles 19-21, where when the data moving operator is the data expansion operator, determining the computation parameter information of the data moving operator includes: taking the first data shape information as the computation parameter information.

Article 24. A computing apparatus configured to optimize a computing graph or perform data processing, including; a processor configured to perform a program instruction; and a storage configured to store the program instruction, where when the program instruction is loaded and performed by the processor, the processor performs the computing graph optimization method of any one of articles 1-11 or the data processing method of any one of articles 12-23.

Article 25. A computer readable storage medium, on which a program instruction is stored, where when the program instruction is loaded and performed by a processor, the processor performs the computing graph optimization method of any one of articles 1-11 or the data processing method of any one of articles 12-23.

Article 26. A computer program product, including a computer program or instruction, where when the computer program or instruction is performed by a processor, the computing graph optimization method of any one of articles 1-11 or the data processing method of any one of articles 12-23 is implemented.

The embodiments of the present disclosure have been described in detail above. The present disclosure explains principles and implementations of the present disclosure with specific examples. Descriptions of the embodiments above are used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

1: A computing graph optimization method, comprising:
traversing an operator associated with tensor data in a computing graph; and
extracting the operator to construct a view-class operator subgraph when the operator is a view-class operator, wherein the view-class operator subgraph is used to perform memory data contiguity processing.

2: The method of claim 1, wherein extracting the operator to construct the view-class operator subgraph comprises:
associatively caching operator information and an operator sequence number of the operator; and
adding the operator sequence number to the view-class operator subgraph.

3: The method of claim 2, wherein extracting the operator to construct the view-class operator subgraph further comprises:
checking whether the operator information of the operator has been cached;
generating the operator sequence number for the operator and performing the caching and adding if the operator information of the operator is not cached; and
adding the operator sequence number of the operator, which has been cached, to the view-class operator subgraph if the operator information of the operator has been cached.

4: The method of claim 2, wherein the operator information of the operator comprises at least one of followings: description information of input data of the operator, description information of output data of the operator, and computation parameters of the operator.

5: The method of any one of claim 1, wherein extracting the operator to construct the view-class operator subgraph further comprises:
when the operator is a multi-branch operator, constructing a view-class operator subgraph with a corresponding number of branches based on the multi-branch operator.

6: A computing graph optimization method, comprising:
acquiring a view-class operator subgraph of tensor data in a computing graph, wherein the view-class operator subgraph comprises a view-class source operator associated with the tensor data;
replacing the source operator with a target operator whose specified function is interchangeable with that of the source operator according to a function of the source operator in the view-class operator subgraph; and
fusing a plurality of contiguous identical target operators into a single target operator to generate a fused view-class operator subgraph.

7: The method of claim 6, wherein fusing the plurality of contiguous identical target operators into the single target operator comprises:
merging dimension operations of the plurality of target operators, such that the single target operator after the fusion is equivalent to the plurality of target operators before the fusion.

8: The method of claim 6, further comprising:
adjusting a position of a specific type of target operator for postponement processing after the fusion is performed, wherein the specific type of target operator is an expand-class operator that causes an increase in memory data.

9: The method of claim 8, wherein adjusting the position of the specific type of target operator for the postponement processing comprises:
according to positions of the specific type of target operator before and after the adjustment, modifying parameters of target operators between the two positions in the view-class operator subgraph to adapt to the adjustment.

10. (canceled)

11. (canceled)

12: A data processing method, comprising:
acquiring a view-class operator subgraph of to-be-processed tensor data in response to the tensor data being discontiguous in memory, wherein the view-class operator subgraph is constructed or generated according to the method as claimed in claim 1; and
calling a corresponding kernel to perform data moving according to information of the view-class operator subgraph to convert the tensor data into tensor data that is contiguous in memory.

13: The method of claim 12, wherein calling the corresponding kernel to perform the data moving comprises:
analyzing operator types in the view-class operator subgraph, and calling kernels matching the operator types to perform data moving, wherein the kernels move the data by block according to the operator types.

14: A data processing method, comprising:
determining a view-class operator through which a to-be-processed first tensor converts from a memory contiguous state into a memory discontiguous state according to first description information of the first tensor in response to the first tensor being in the memory discontiguous state;
determining a data moving operator in a computing library that needs to be called according to the view-class operator;
determining a parameter required for calling the data moving operator to convert the first tensor from the memory discontiguous state into the memory contiguous state according to the first description information; and
calling the data moving operator according to the parameter to convert the first tensor into the memory contiguous state.

15: The method of claim 14, wherein determining the view-class operator experienced by the first tensor comprises:
determining the view-class operator experienced by the first tensor according to first data shape information and first dimension stride information in the first description information.

16: The method of claim 15, wherein determining the view-class operator experienced by the first tensor further comprises:
determining the view-class operator experienced by the first tensor to be a rearrangement view-class operator when a data size indicated by the first data shape information is consistent with a memory size to which the first tensor is directed, and the first dimension stride information indicates that each dimension stride is arranged in a non-descending order; or
determining the view-class operator experienced by the first tensor to be an expansion view-class operator when there is a dimension stride with a 0 value in the first dimension stride information, and a data size obtained by adjusting the first data shape information according to a position index of the 0 value is consistent with the memory size to which the first tensor data is directed.

17. (canceled)

18: The method of claim 14, wherein determining the data moving operator that needs to be called according to the view-class operator comprises:
determining the data moving operator that needs to be called to be a data rearrangement operator when the view-class operator is a rearrangement view-class operator; or
determining the data moving operator that needs to be called to be a data expansion operator when the view-class operator is an expansion view-class operator.

19: The method of claim 14, wherein determining the parameter required for calling the data moving operator comprises:
determining second description information of a second tensor serving as an input tensor of the data moving operator; and
determining computation parameter information of the data moving operator.

20: The method of claim 19, wherein determining the second description information of the second tensor comprises:
when the data moving operator is a data rearrangement operator, determining a descending arrangement of first dimension stride information in the first description information as second dimension stride information in the second description information of the second tensor, and
converting first data shape information in the first description information according to a rule of converting the first dimension stride information into the descending arrangement to obtain second data shape information in the second description information; or
when the data moving operator is a data expansion operator, acquiring a position index of a 0 value from the first dimension stride information in the first description information,
setting a corresponding position of the first data shape information in the first description information to 1 according to the position index of the 0 value to determine the second data shape information in the second description information, and
determining the second dimension stride information in the second description information according to the second data shape information and a memory contiguity rule.

21. (canceled)

22: The method of claim 19, wherein determining the computation parameter information of the data moving operator comprises:
when the data moving operator is a data rearrangement operator, taking the second tensor as an input of the data moving operator,
taking the first tensor as an output of the data moving operator, and
deducing the computation parameter information of the data moving operator based on the first description information and the second description information; or
when the data moving operator is a data expansion operator, taking first data shape information as the computation parameter information.

23. (canceled)

24: A computing apparatus configured to optimize a computing graph or perform data processing, comprising:
a processor configured to perform a program instruction; and
a storage configured to store the program instruction, wherein when the program instruction is loaded and performed by the processor, the processor performs the computing graph optimization method of claim 1.

25. (canceled)

26. (canceled)

27: A computing apparatus configured to optimize a computing graph or perform data processing, comprising:
a processor configured to perform a program instruction; and
a storage configured to store the program instruction, wherein when the program instruction is loaded and performed by the processor, the data processing method of claim 12.
